(19) United States
(12) Patent Application Publication
(10) Pub. No.: US 2007/0150810 A1
(43) Pub. Date: Jun. 28, 2007

(54) Virtual desktop

(76) Inventors: Itay Katz, Tel-Aviv (IL); Eran Palatnik, New York, NY (US); Gil Lederman, Haife (IL)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 10/560,991

(22) PCT Filed: Jun. 25, 2004
(86) PCT No.: PCT/US04/20460

§ 371 Date: Dec. 18, 2006

Related U.S. Application Data
(60) Provisional application No. 60/483,304, filed on Jun. 27, 2003.

(51) Int. Cl. G06F 17/00; G06F 15/00

(52) U.S. Cl. 715/526

(57) ABSTRACT

Virtual Desktop—Meta-Organization & Control System wherein a real-time-accessible memory media having at least one dynamic substantially cyclic electronic-data structure is associated (by an ongoing algorithmic activity for respectively regularly transforming each process of a plurality of processes running in the environment) into an associated graphic representation, and logically assigns the representation to a location in the data structure—such that for the data structure, a graphic user interface facilitates viewing of the representations assigned to at least one of the data structures and facilitates organizing of the at least one data structure.

This application claims priority to VIRTUAL DESKTOP (“DeskLoops”)—a provisional U.S. Application Ser. No. 60/483,304, filed Jun. 27, 2003—and hereby incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD OF THE INVENTION

The present invention generally relates to Graphical User Interfaces (GUI) of Computer Systems; including those for common personal computers, laptop computers, personal data assistants, advanced wireless communications devices having imbedded computational applications, “thin” client front end systems (relying on server bases CPU engines), distributed computing systems, parallel processing systems, synchronous and asynchronous amorphous computing communities (e.g. SETI—Search for Extraterrestrial Intelligence), and the likes.

More specifically, the present invention relates to visual organization and awareness facilitation for users accessing multiple applications in process; including independent processes and interdependent processes—which in some applications is sometimes called a “virtual desktop”.

From the perspective of the computerized applications in process, per se, the present invention relates to interactive command-control facilities and/or to observation monitoring (e.g. passive viewing of status, alert activating, alarm activating, etc.); including real time financial data stream transaction interactions, project management & coordination, integration of physiological monitors and medical information systems, genomic computation strategies, artistic composition arrangement protocols (e.g. orchestration, cinematography production management, multimedia performance events, etc.), and the likes.

### BACKGROUND ART OF THE INVENTION

Today, from the perspective of an ordinary computer user, use of multiple substantially simultaneous functions is a mundane everyday activity. For example, a typical user may have open applications for electronic mail, word processing, streaming media (net-radio), web browsers, a chat room (electronic messaging), a graphic applications package (e.g. PowerPoint or Architecture or CAD/CAM), and an accounting package (e.g. spread-sheet). By “running” back and forth between them, he distributes his interests and accomplishes his increasingly diverse tasks.

Now, the GUI, allowing the regular user to swap his focus from one application to another, generally transforms the user into a sequential task operator—while the user would prefer some ergonomic way to expand his facility and participate in multiple activities—virtually simultaneously. Transcending this obscure example into a more robust case, we find many management administrators eager to keep an active and interactive monitoring of all subordinate activities and transactions. However, the same “plod along” GUI systems that return the regular user to sequential mode likewise constrict the manager's field of view and range of activities to similar sequential modes. While the longstanding need for this expanded view and interactivity has long been sought after and, at greatest imaginable expense, developed for instantiation specific military applications, both the ordinary user and the common management administrator continue to await a generic interface that will allow them to take command-control of the same level of responsibility over their respective interests.

This is not an unreasonable expectation, especially since (from the user perspective) the complexity of running simultaneous onboard program processes appears transparently similar to expanding those processes to include group-ware interactions with other members of a computer communications interconnected team; which in turn appears transparently similar to including management, administration, and transactional facilities to either process collection. Furthermore, increasingly the user is simultaneously involved in multiple semi-autonomous activities, relating to his personal life, his employment, and his Internet social-information “milieu” which may parallel his personal and professional lives or which may perversely supplement them—with actualizations of apparently antisocial activities, amoral curiosities, “experimental” interests, and transient “investigations”. Within each of these normal public and private pursuits, the user increasingly develops new skills and pursues self education in order to perform tasks and transactions which were heretofore facilitated through specialized human assistance agents—such as travel booking, medical awareness, day-trading, e-commerce, dating, market research, etc.

Thus, in light of the longstanding need for facile multi-program organization and control of interactivity, essentially motivated by a generally appreciated humble consumer expectation, it comes as a historical surprise to observe that no generic intuitive manageable software system has been successfully presented for public use. Nevertheless, numerous convoluted attempts are well documented—and are hereby incorporated by reference, including: PCT/US96/11765 PCT/US99/08669 PCT/IL00/00504 (by one of the present inventors) PCT/FI03/00315 U.S. Pat. No. 6,308,199 U.S. Pat. No. 6,687,878 and PCT/US00/28319. Each of these prior art references, while trying to construct some generic general purpose meta-organizational system for computer active processes and the likes, fails to arrive at a sufficiently intuitive interface format to allow ordinary users of diverse backgrounds to appreciate advantages—by reason of narrowly configures non-facile man-machine interaction formats (including the GUI). Furthermore, there is no apparent cognitive step that would allow an ordinary person (skilled in the art) to combine these references and arrive at a facile solution—rather it seems that combining these references would produce a most confusing user interface. Nevertheless, according to our best knowledge, these are the closest references in the ordinary accessible literature—and the present invention will be shown to exhibit not less than a reasonable modicum of progress over each of these, both jointly and individually.

Shared Virtual Desktop Collaborative Application System PCT/US96/11765 (WO 97/04383) Abstract: “A computer system, including a processor, an input device and an output device and that executes an operating system to support the execution, is used to execute first and second sets of application programs. The operating system includes a graphical user interface couple-able through an output driver to the output device and an input interface including an input queue couple-able through an input driver to the input device. The processor also executes an environment manager program. This program includes a third list of a second set of application programs and a fourth list of application program windows corresponding to the second list of application programs. Execution of the environment manager program provides for the inclusion of the environment manager program in the first and second sets and for selectively swapping with the operating system the first and third lists and the second and fourth lists to switch between the execution of the first and second sets of application programs.” Analysis: The apparent embodiment here seems to require specialized user training and a specific user mentality to be facile; thus they do not seem to rise to the level of fulfilling the longstanding need in the art.

Method And Apparatus For Providing A Virtual Desktop System Architecture PCT/US99/08669 (WO 99/54804) Abstract: “The invention provides a central office metaphor for computing, where features and functions are provided by one or more servers and communicated to an appliance terminal through a network. Data providers are defined as “services” and are provided by one or more processing resources. The services communicate to display terminals through a network, such as Ethernet. The terminals are configured to display data, and to send keyboard, cursor, audio, and video data through the network to the processing server. Functionality is partitioned so that databases, server and graphical user interface functions are provided by the services, and the terminal provides human interface functionality. Communication with the terminals from various services is accomplished by converting disparate output to a common protocol. Appropriate drivers are provided for each service to allow protocol conversion. Multiple terminals are coupled to the network. Users can enable their unique session at any one of the terminals by inserting a “smart card” into a card reader. Removing the card disables the session. Re-inserting the card into the same or any other terminal re-enables the session.” Analysis: The apparent embodiment here seems to “nostalgically” expect that the interface architecture of long obsolete telecommunications communities to meet the real time complexity expectations of today's users—albeit without the re-invention of punched paper tape; likewise failing to rise to the level of fulfilling the longstanding need in the art.

Method And Apparatus For Improving The Virtual Desktop PCT/IL00/00504 (WO 01/14956) Abstract: “An improved virtual desktop relates to a method and an apparatus for improving the quality of the work interface between people and computer, and to a facile command-control system, including (A) a computer workstation having therein at least one presentation format wherein a plurality of icon-objects are stored for representation on an associated graphic display device, and dynamic icon-object management software of the workstation configures the presentation format icon-objects into a virtual desktop of the icon-objects; and (B) a command-control apparatus, interconnected to the workstation, for transmitting control commands to the workstation, wherein at least one of the control commands elicits an action by the dynamic icon-object management software.” Analysis: Here, as in the other prior art citations, even an inventor of the present invention failed to glance over-the-horizon and appreciate the juncture of user interface simplicity necessary to facilitate complex meta-organization and management of ongoing computer processes; thus also failing to rise to the level of fulfilling the longstanding need in the art.

Graphical User Interface And Method And Electronic Device For Navigating In The Graphical User Interface PCT/FI03/00315 (WO 03/091867) Abstract: “The present describes a method, graphical user interface and electronic device for forming guiding lines in a graphical user interface of an electronic device comprising at least a display and navigating means, wherein a portion of virtual desktop area of said graphical user interface is seen on the display at a time. In the method, digital material is placed on the virtual desktop area. The method further comprises the steps of determining a point of origin within the digital material and defining at least two points through which a guiding line is drawn, the guiding line indicating the distance and/or direction to the point of origin. The guiding line is then displayed along with the digital material on the display.” Analysis: The apparent embodiment here seems to somewhat appreciate the universal needs for logically simple GUI for meta-organizational process monitoring and control; however the specific instantiations do not answer the longstanding need in the art.

Cooperative Work Support System For Managing A Window Display U.S. Pat. No. 6,308,199 Abstract: “In an application sharing system in which a plurality of users can make discussions using a relationship among pieces of information extending to a plurality of application windows, there is provided the ability to select windows to be displayed and windows to be hidden for each user. In the system, an application included in one computer is shared by a plurality of computers connected through a network and display screens produced by the application are shared. In a computer having the shared application, whether to display or hide, for each user, windows displayed in the course of screen display shared other computers is controlled by a display control unit. There is provided a user information management unit that manages user information indicating for each user whether to display or hide each window. The display control unit determines whether to display or hide for each user, using the user information in the user information management unit.” Analysis: The apparent embodiment here seems to ignore the fact that not intuitive meta-organization GUI is available—and thus scale up existing flawed management interfaces into grand groupware (trans-server linked) architectures.

Synchronizing/Updating Local Client Notes With Annotations Previously Made By Other Clients In A Notes Database (groupware version control protocol) U.S. Pat. No. 6,687,878 Abstract: “A with a document, such as an image or text document, are stored in a notes database on a central notes server. The documents and associated annotations are treated independently from each other whereby separate data structures are created for the documents and for the associated annotations. A web server application on the server side functions to capture requests from one or more note client applications for creating, storing, editing and retrieving annotations related to specific documents stored on the notes server. On the client side, the notes client functions to display the document that the user wishes to annotate and provides the tools necessary to permit the user to create, edit, delete, retrieve and store notes. A synchronization process transmits the annotations generated by the user from the notes client to the notes server. In response, the notes server transmits back an acknowledgement along with any new notes that other notes clients may have posted since the last synchronization was performed thus enabling multiple notes clients to annotate a document asynchronously with respect to each other. When annotations are posted to the notes server by a notes client, the state of the annotation database is synchronized such that all other notes clients can retrieve the current, up to date annotations associated with a document.” Analysis: Apparent embodiments here seem to appreciate that version control protocols would help in resolving the mess that dominates groupware environments—but fails to solve basic GUI meta-organizational issues.

A Knowledge-Engineering Protocol-Suite PCT/US00/28319 (WO 01/33501) Abstract: “A Knowledge-Engineering Protocol-Suite is presented that generally includes methods and systems, apparatus for search-space organizational validation, and appurtenances for use therewith. The protocol-suite includes a search-space organizational validation method for synergistically combining knowledge bases of disparate resolution data-sets, such as by actual or simulated integrating of lower resolution expert-experience based model-like templates to higher resolution empirical data-capture dense quantitative search-spaces. Furthermore, from alternative technological vantages, the suite relates to situations where this synergetic combining is beneficially accomplished, such as in control systems, command control systems, command control communications systems, computational apparatus associated with the aforesaid, and to quantitative modeling and measuring tools used therewith. The protocol-suite also includes facile algorithmic tools for use with the method and a process-modeling computer for use in a distributed asynchronous system of modeling computers.” Analysis: Apparent embodiments here seem to appreciate that there is a need for meta-organization, process-coordination, and intelligent control mechanisms—however, like all of the aforesaid citations, they too fail to find a robust intuitive GUI that lets an ordinary user interface with what is increasingly a radically complex processing milieu.

Summarizing the prior art, one finds that sophisticated well-funded computer system users have unfulfilled needs for simplistic GUI interface systems that facilitate meta-organization and appropriate control functions. Thus, it has seemed reasonable that ordinary modestly funded users should expect to wait a long time until their specification diverse instances would find facile solution. Stated simply, the user doesn't care if a process is running on his machine or elsewhere via some data-communications-topology—he wants a generic intuitive way to simultaneously be able to see what's going on, to interact however he thinks is appropriate, and to get processes to interact with each other too; and this is a longstanding need that is progressively more unfulfilled—as processes and topologies become more sophisticated.

### DISCLOSURE OF INVENTION

The aforesaid longstanding needs are significantly addressed by embodiments of the present invention, which specifically relates to a Virtual Desktop—Meta-Organization & Control System. The instant system is especially useful in man-computer interactions wherein there exists a need for a generic intuitive way for a user to simultaneously be able to see what's going on in a multi-process environment and to interact with broadest latitude with these processes as appropriate; and preferably to get processes to interact with each other too.

Turning to Principal embodiments of the instant invention relate to A Virtual Desktop—Meta-Organization & Control System, for use in a computer-processing environment having therein at least one processing unit with a respective operating-system, and the Virtual Desktop system comprises: A. In a real-time-accessible memory media, at least one dynamic substantially cyclic electronic-data structure (see FIG. 1—210, 220, 230); B. Associated with each said data structure, an ongoing algorithmic activity that is respectively regularly (I.) Based on respective operating-system data access, Transforming each process, of a plurality of processes running in the environment or in a predetermined portion thereof, into an associated graphic representation (see FIG. 2—310, 312, 314, 316, 318), and (II.) Logically assigning the representation to a location in the data structure; and C. Associated with each said data structure, a graphic user interface facilitating (I.) On a display device (see FIG. 3—310), viewing of the representations assigned to at least one of the data structures or to a portion thereof, and (II.) Organizing (see FIG. 4-410) of the at least one data structure.

More specifically, Principal embodiments of the instant invention relate to A Virtual Desktop—Organization & Control System, for use in a computer-processing environment having at least one processing unit therein, and the system comprises the three elements A, B, and C—further described immediately hereinafter.

A. In a real-time-accessible memory media, at least one dynamic substantially cyclic electronic-data structure—and the structure is “substantially” cyclic in that application to very long data series (e.g. financial data series, genomic sequence series, etc.) makes the formation of an end to end linkage trivial—while in using instant embodiments for organization of processes and graphic representations thereof, the cyclic feature immediately provides an intuitive meta-organizational element (well known in the “analog world” by the example of Flexible Volume Rolodex organizers; and well known in the “digital world” by the examples of LISP GUIs—“evolved” from John McCarthy's List Processing Languages). Implementation of the data structure may be as a simple linked list; or even as a sparse array (that is effectively compressed—such as by run-length encoding—to allow presentation of a sequential portion) and then artificially made cyclic (if necessary) by setting a pointer at the end that points back to the beginning (and bi-directionally etc.).

B. Associated with each said data structure, an ongoing algorithmic activity that is respectively regularly (I.) Based on respective operating-system data access, Transforming each process, of a plurality of processes running in the environment or in a predetermined portion thereof, into an associated graphic representation, and (II.) Logically assigning the representation to a location in the data structure—and the transformations may be straightforward like a snapshot of the current GUI display from the process or the transformations may be meta-representations of aggregates of process or the transformations may be recursive snapshots of relations between one or more processes applicable to one instant invention cyclic structure with one or more processes applicable to another instant invention cyclic structure (multi tier embodiments). The respective operating-system access is in the case of the instant invention embodiment spanning multiple computers via some protocol compliant mutual data-communications topology; while for core technology embodiments, there is only the operating system of the underlying computer, per se.

C. Associated with each said data structure, a graphic user interface facilitating (I.) On a display device, viewing of the representations assigned to at least one of the data structures or to a portion thereof, and (II.) Organizing of the at least one data structure—and the representation may be static realistic graphic images, static symbolic graphic images, dynamic realistic graphic images, condition actuated graphic images. Fundamentally, for audio enabled computer-processing environments, some of the “images” may be audio sound bites, audio data streams, or the likes. Nevertheless the aim of the organizing is to allow a currently preferred sequentially ordering of representations for each data structure.

Now, simply stated, from the perspective of a user of a core technology embodiment of the instant invention (described in detail in the “Modes For Carrying Out The Invention” Section—below), there is at least one horizontal cross-section of the user's display that is allocated for the presentation of intelligent visualizations. These visualizations may be of user application processes running on the user's machine or of user related processes in a user allocated virtual address space of an interconnected server architecture or of processes of interest to the user in some public or private information-hyperspace or of application processes of interest to the user running on a server interconnected non-user machine or of any digital system processes resident in any of the aforesaid or of data-communications processes interconnected thereto.

In that the user is master of the organization of the substantially cyclic data structure underpinning the cross-section, numerous facile and intuitive operations allow the user to sequentially bi-directionally thrash through the representations (endlessly since the structure is cyclic), swap between representations on the cross-section and the processes that they respectively monitor, re-organize sequencing of representations on the cross-section, and the likes—all of which is an advice over task-bars, static menus, control codes, and custom applications set specific management software visualization tools. Intrinsic to the facile side of the instant invention is the ability to re-organize the relative positions of the representations on the cyclic data structure, to elect which sub set of those representations are observable on screen, to use observable representations as a quick interface to enter (call up) interactions with process associated with the representation, and the likes.

The simplest straightforward application of the instant invention is for the typical Personal Computer user who simultaneously has many running processes on his machine—such as electronic mail, word processing, streaming media (net-radio), web browsers, a chat room (electronic messaging), a graphic applications package (e.g. PowerPoint or Architecture or CAD/CAM), and an accounting package. In fact, when working on a text document, he may have multiple text documents and even multiple web-browsers open to accomplish his document composition task. Accordingly, using the core technology embodiments of the instant invention provides the user with a visually intelligent alternative for the current static-stack task bar.

Regarding the plethora of application specific embodiments according to the present invention, there are two base case processes—one that operates on discrete operating programs (core technology embodiments described in detail in the “Modes For Carrying Out The Invention” section—below) and the other that operates on an underlying very-long static data series or substantially ongoing dynamic data series.

Discrete Operating Programs Base Case

In this variation, embodiments of the present invention preferably consider user application programs as the processes having static or dynamic snapshots displayed on the graphic representation of the substantially cyclic electronic-data structure. Examples of such static representations include acrobat reader, Microsoft word, Norton Anti-Virus, Microsoft Internet Explorer, Excel for Windows, etc. while examples of dynamic representations include video streams, RealOne Player, QuickTime Player, etc. So it is preferred in this base case for the “at least one dynamic substantially cyclic electronic-data structure” to actually be a single solitary structure.

An interesting exception to this preference for this case is where the user saves structure configurations—so that he can simultaneously re-activate a plurality of processes and continue his activities from where he left off. For example, the user may have a pre-configured structure having processes for personal games and entertainment, or for personal communications, or for business activities, of for groupware project tool and data sharing (via a data-communications topology such as the Internet, LAN, WAN, etc.).

Another interesting exception to this preference is using the cyclic data structure, as a common C3 reference for multiple users who are participating in a group activity—be that project development, education, or recreation; and the common reference is provided via server architecture groupware (Internet, etc.) or as a homepage URL of a website—since the visualization representation is an easy to reconfigure index of virtually countless individual processes (e.g. WebPages) or recursively as a meta-organization for a plurality of other substantially cyclic data structures (of processes or of cyclic data structures, etc.)

Data Series Base Case

In this variation, embodiments of the present invention preferably consider user application programs as the processes having a predetermined lengthy set of sequential data or a live stream of data displayed on the graphic representation of the substantially cyclic electronic-data structure. Examples of static representations include historic econometric or census data, base pairs in a predetermined genome, notes in a musical composition, steps in an industrial process, stages in a managed pre-planned project, and the likes—while examples of live stream data includes stock market prices, currency market prices, measurements from a physiological monitor or from a seismic monitor or from weather monitoring apparatus or the likes. Turning to FIG. 14 (1400), there are six parallel substantially cyclic data structures (portrayed in this example as having a common time scale that is synchronous). Starting from the bottom, there are two data series, having the data produced from a mathematical correlation function shown above them. Thereabove, is a stream of alerts whenever the correlation produces a result beyond a predetermined threshold (or condition). A plurality of proximate alerts will trigger an alarm event, which in turn will allow for the intervention of a decision maker. One application of this example relates to streams of stock process at the bottom, which eventually result in a manager issuing directives to his subordinate brokers to “intervene” with specific types of financial transactions. Another application of this example begins with two physiology monitors and culminates with medical intervention activities. In the case of medical information systems, the decisions could be recursively summarized in SOAP record keeping format—as four parallel “events” on respective substantially cyclic data structures, etc.

Now, with regard to these types of Data Series Base Case, there are three classes of longstanding needs for which embodiments of the instant invention provide inventive progress—even in light of the prior art citation listed above and also the citations listed therein! The first class is a need for improved data visualization, for incremental graphic visualization, and for terrain-type data-“environmental” visualization. The second class is a need for improved Meta-organization of data density, density of detail, and presentations of data index stratification. The third class relates to a need for improved Server-Side groupware (linked to a single common loop or to a plurality of inter-related loops) and to Internet Portal organization-of-content-access (using embodiments of the instant invention to format “homepage” URLs, etc.).

In addition, according to another embodiment of the instant invention A Virtual Desktop—Meta-Organization & Control System, the at least one dynamic substantially cyclic electronic-data structure includes a reduced resolution meta-data-structure having pointers to locations in the cyclic electronic-data structure.

Likewise, according to yet another embodiment of the instant invention A Virtual Desktop—Meta-Organization & Control System, the ongoing algorithmic activity includes at least one program substantially as hereinafter described and illustrated and selected from the list: UIManager (UI), MapManager (MAP), AnimatorManager (ANIM), SystemHookManager (SYSHOOK), ScrollManager (SCROLLER), Executable Code Core Algorithm Group (ECCAG).

Furthermore, according to still another embodiment of the instant invention A Virtual Desktop—Meta-Organization & Control System, the associated graphic representation is selected from the list: high resolution snapshot of a GUI of the process, a low resolution snapshot of a GUI of the process, a symbolic graphic representation for the process, a high resolution data stream of a GUI of the process, a low resolution data stream of a GUI of the process, a symbolic graphic representation data stream for states of the process.

Now, according to some very interesting embodiments of the instant invention A Virtual Desktop—Meta-Organization & Control System, the plurality of processes is selected from the list:

A. at least two programs selected from the group: electronic mail, word processing, streaming media, net-radio, net-television, net-video, web browser, chat room, electronic messaging, graphic application package, PowerPoint, Architecture support program, interior design support program, CAD/CAM, accounting support program, spread-sheet program;

B. at least two programs selected from the group: real time financial data stream presentation program, transaction events validation program, aggregate analysis of transaction events program, collective transaction management support program, financial analysis alert program, financial analysis alarm program, day-trader interaction program, brokerage management directive program;

C. at least two programs selected from the group: project management program, supply chain program, scheduling program, accounting program, project coordination program, resource allocation program;

D. at least two programs selected from the group: ECG monitor program, EEG monitor program, physiological monitor program, medical history report program, drug interaction program, medical expert system program, correlation of physiological monitors program, medical condition alerts program, medical condition alarm program, medical information system program;

E. at least two programs selected from the group: genomic data base series display program, local search genomic fragment identification computation program, correlation to known organic compounds identification program, genomic computation strategy comparison program;

F. at least two programs selected from the group: artistic composition arrangement protocol, orchestration program cinematography production management program, animation program audio special effects program, visual special effects program, multimedia performance event program, film editing program, audio editing program, audio mixing program, visual series mixing and sequencing program;

G at least two programs selected from the group: an interactive command-control facility program, an observation monitoring program, a passive viewing of status program, an alert activating program, an alarm activating program; and

H. a first program selected from any of the aforesaid groups, a second program selected from any of the aforesaid groups, and a third program interrelating data content from the first program with data content from the second program.

Thus, From the perspective of the computerized applications in process, per se, data stream and/or data series embodiments of the present invention relate to interactive command-control facilities and/or to observation monitoring (e.g. passive viewing of status, alert activating, alarm activating, etc.); including real time financial data stream transaction interactions, project management & coordination, integration of physiological monitors and medical information systems, genomic computation strategies, artistic composition arrangement protocols (e.g. orchestration, cinematography production management, multimedia performance events, etc.), and the likes.

However, most simply stated, the instant invention relates to embodiments of A Virtual Desktop—Meta-Organization & Control System, substantially as herein described and illustrated, and characterized by having at least one cyclic data structure, and associated therewith a mini-map module and an operating system interface.

Core Technology embodiments of the instant system enable the user to save the current ring (the windows and their position on the ring) and by that, enable to continue with exactly the same working environment in other time. User can have assorted “Templates rings” (e.g. ring with University material applications, Work applications, News ring, Hobby ring, etc.) and “Snapshots rings”, ones that was saved in a certain moment during working with the computer. Regarding hand-eye coordination compensation methods, this is enabled in very simple and intuitive ways—to rotate the ring. Furthermore, “Mini-map” includes the actual display of the windows on the ring, but in small and configurable size. The user can define the size and the number of displayed windows, by dragging the bottom of the Mini-map up and down (up: will increase the number of the displayed windows, while decreasing their size). Navigating with the Mini-map is similar to navigate the real ring. Finally, the system can be used with personal computers, PDAs, cellular phones, set boxes, TVs, and the likes.

Instant embodiments facilitate a most general meta-organization & control pattern by which to represent, navigate through, and manipulate a dynamically changing “virtual display” of an arbitrary set of icon objects.

An icon object is defined generally as any representation of an application (an operating system application, HTML page, web application, etc.). The specific current thinking for the embodiment of the technology is set forth below. However, the definition herein is intended to include all applications and variations on this specific current thinking and all component parts thereof.

The instant system embodied in software, is composed of two main parts—the novel display manager, and the complementing “Mini-Map” desktop navigation tool. The goal is to provide a virtual desktop that is intuitive and manageable. This goal is achieved by creating a new virtual concept of a “loop”, while the application windows are placed one next to other instead of overlapping each other.

Embodiments of the instant system stretch the desktop along a virtual Loop, thus allowing the user to smoothly and continuously rotate the desktop, achieving an effective desktop size as large as the user may wish to define. The Loop is circular; therefore, if the user scrolls to the right, the display will eventually return to its original starting point. This way the user may never “get lost” in the Loop environment. When a new window application is opened (e.g. Microsoft Explorer), it is integrated into the “Loop” automatically or by double clicking on tray icon (or possibly a keyboard/mouse combination). The window can be integrated to the Loop between the current application's windows that the user sees on the screen, or to the “right end” of the loop. In the first case, the desktop will be stretched to the side and open an “empty space” between the current application's windows displayed on the screen, a space where the new window will be placed. The placement operation can be done with animation, or immediately. When a user closes an application, the loop will close up on the vacant space, maintaining uncluttered desktop. The display manager is fully compatible with the operating system built-in methods for application manipulation.

If the user wishes to move the position of a window, and then to place it into the “Loop” again, it can be done at any time by double-clicking the tray icon or using the mouse/keyboard combination.

Navigation Tools

The Automatic Window Position Predictor (AWPP) feature of the system is designed to improve the user hand-to-eye coordination. The AWPP comes into action whenever the user initiates a Loop-movement. It computes the most likely ending-position of the current movement, and therefore is able to compensate for minor imprecision's of the user. For example, when the user moves the Loop towards a full-sized window and ends the movement while the aforementioned window is not aligned exactly to the borders of the display, the AWPP will presume that what the user actually wanted to achieve was to align the window with the display border, and so seamlessly correct the user input to achieve this end.

When a user presses alt-tab or uses the task-bar to switch applications, the Loop will automatically rotate to bring the selected application into view. Furthermore, this platform enables the user to drag-and-drop (Microsoft Windows OS feature) between applications in a very easy manner. The user drags the object to the end of the screen until the target application is displayed, and simply drops the object in that application.

“Back-Forward”: As the user changes his active window, the system will save a history of the active windows, and will provide the user with an interface of two arrows (back and forward) that browse through the active windows history. Whenever the user moves back or forward in the windows history, the entire Loop will be rotated to bring the desired window to the center of display.

“Loop Coloring”: In order to improve user orientation, the Loop is divided into quarters, and in each quarter the background is colored differently.

“Loop Icons”:

1. A flat icon representation of the Loop, divided into four quarters, each colored according to the previously defined “Loop Coloring”. Clicking on one of the quarters will rotate the Loop to the beginning of that quarter.

2. A 3D picture of the Loop, colored appropriately, which presents miniaturized pictures of the entire current quarter. As with the first icon, the user can click on any part of the 3D Loop icon, and the Loop will rotate accordingly.

“History”: A mini-map icon will open up a History of the HTML pages the user had visited. Each page will be accompanied by a small miniaturized picture of the HTML page.

“Recent Files”: A list of the files recently used on the Loop, that are not currently open on it. The list will be presented in a similar manner to the “active Loop” mini-map (i.e, every recent file will be accompanied by a miniaturized picture).

Display Features

“Window Grouping”: This feature ascribes a window to a specific Loop position according to its content (and type of application). For example, one policy could be a group together all Word windows, so that whenever a new Word window is opened, it is positioned adjacent to the other open Word windows on the Loop.

“3D support”: Recently, 3D monitors had been introduced to the market. These monitors support a 3D illusion (similar to iMax cinemas). On such hardware, the system will facilitate a display of a larger part of the Loop, beyond the one screen-size that is possible on standard hardware. This will be accomplished by presenting a portion of the Loop that is adjacent to the foreground window in the 3D space of the display, so that the Loop will appear to be curved along the screen. The user will get the feeling that he is located at the center of the Loop.

‘Sticky window’ feature enables the user to define an application window to retain its position on the screen, while the desktop is being scrolled. This feature can be used for applications such as a Music player; or any application to which the user wishes to have very quick access whiles keeping its window size relatively small.

“Multiple monitors support”: The software supports a multiple-monitors display. The screen size will be computed as the total screen size of all monitors.

“Loop Compactification”: Normally, Web Pages are designed to be viewed by the user in “stand-alone” mode. That is, a single full-sized window. Therefore, many of them includes large margins that would otherwise be considered wasteful in a shared display environment. In a Loop-oriented display, these margins are no longer necessary, and so, when enabled, this feature will automatically resize or otherwise alter Web Browsers to eliminate the wasteful margins, thus allowing the user to view more information in a compact and efficient way.

“Multiple Loop support”: The basic operation of the software is with one virtual Loop. In addition, the software supports the existence of multiple Loops simultaneously. The user may add, remove, name and configure the attributes of each Loop separately, and relocate windows from one Loop to another.

The software provides an interface that allows the user to quickly navigate between the Loops.

“Increased MAX window size”: In normal operation of the operating system, there is hardly any sense in allowing for windows larger than the size of the screen. However, the Loop-oriented display makes this option a viable one. The software therefore supports the existence of windows of a size larger than the screen. For example, Integrated Development Environments (such as Microsoft .NET IDE) could benefit from such an option.

Interface

The interface is simple and intuitive, based on the mouse, or any other pointing or scrolling device, and/or the keyboard:

As the user moves the mouse pointer to the right end of the display, the desktop automatically scrolls to the right, revealing the “hidden” part of the loop. The scrolling is continuous, and the speed of the scrolling may be controlled by the relative height of the mouse pointer on the display.

Scrolling is performed by moving the mouse to the direction which the desktop should scroll to, while pressing on the mouse's middle button. For example: if the user presses the middle button and moves the mouse to the right, the desktop will scroll to the right. The speed of the scrolling of the desktop is dependent on the distance the mouse moved from the point where the user pressed the middle button, and the current position of the mouse. As the distance gets bigger, the desktop will move faster.

Discrete Scrolling a): A keyboard combination will allow the user to rotate the Loop one window at a time. The movement will be animated, and will end as the next window on the Loop is brought to the center of the display.

Discrete Scrolling b): A keyboard/mouse combination will rotate the Loop a pre-configured distance, with or without animation. For example, ‘Shift’+Mouse wheel rotates one window for every “click” of the wheel.

Saving and Loading of Loops

The software allows the user to save entire Loop formations. The user may later load an entire Loop onto the desktop within a few seconds, thus creating a pre-defined working environment. When saving a Loop, the software will save to a file the entire contents of the Loop(s) the user currently works with. When the user wishes to load a Loop from a an existing file, the software will execute the relevant applications and documents, and will arrange them in the exact same way they were saved. When choosing a file to load, the user will be presented with a miniaturized picture of the available Loops to load, very much like the one displayed on the “Mini-Map” (see below).

The Mini-Map Module

Turning to FIGS. 5 & 6, the software includes a resizable Mini-Map (510, 610) display (520, 620) of the desktop (530, 630). The Mini-Map is a miniature representation of the entire virtual desktop, and it is, in essence, an accurate and complete scaled-down version of the desktop. The user is able to see the contents of every single window or application, as they appear on the screen, in their scaled-down version.

Changes to the desktop in a “hidden” part of the Loop that is not currently displayed on screen are still reflected in the Mini-Map display. On the other hand, changes to the mini-map are in turn reflected to the Desktops. For example, the user may use the mouse to drag a miniaturized window on the Mini-Map to a new location, and the real window on the desktop will be moved accordingly. The Mini-Map may be used to easily navigate the loop—as a user clicks a window on the map, the Loop will automatically rotate to the correct position in order to center that window on the display. The Mini-Map can be configured to auto-hide, and its display can be semi-transparent, so that the contents of the display beneath it can still be seen. To ease user-orientation on the Mini-Map, it will be colored according to the “Loop Coloring” scheme.

### BRIEF DESCRIPTION OF THE DRAWINGS

In order to understand the invention and to see how it may be carried out in practice, embodiments including the preferred embodiment will now be described, by way of non-limiting example only, with reference to the accompanying drawings. Furthermore, a more complete understanding of the present invention and the advantages thereof may be acquired by referring to the following description in consideration of the accompanying drawings, in which like reference numbers indicate like features and wherein:

FIG. 1 illustrates a schematic view of three respectively parallel cyclic data structures;

FIG. 2 illustrates a schematic view of graphic items corresponding to processes that have been sequentially associated with locations on a cyclic data structure;

FIG. 3 illustrates a schematic view of a display whereon is seen one graphic item associated with a cyclic data structure;

FIG. 4 illustrates a schematic view of a display whereon is seen two partial graphic item associated with a cyclic data structure;

FIGS. 5 and 6 illustrate actual screen shots of a display associated with a computer having a best currently implemented mode of the instant invention thereon;

FIG. 7 illustrates a schematic view of the fundamental functional organization of a core technology embodiment of the instant invention;

FIGS. 8-13 illustrate schematic views of various preferred embodiments of the instant invention; and

FIG. 14 illustrates a schematic view of parallel substantially cyclic data structures as seen in a mini-map representation for multiple data series, events, and the likes.

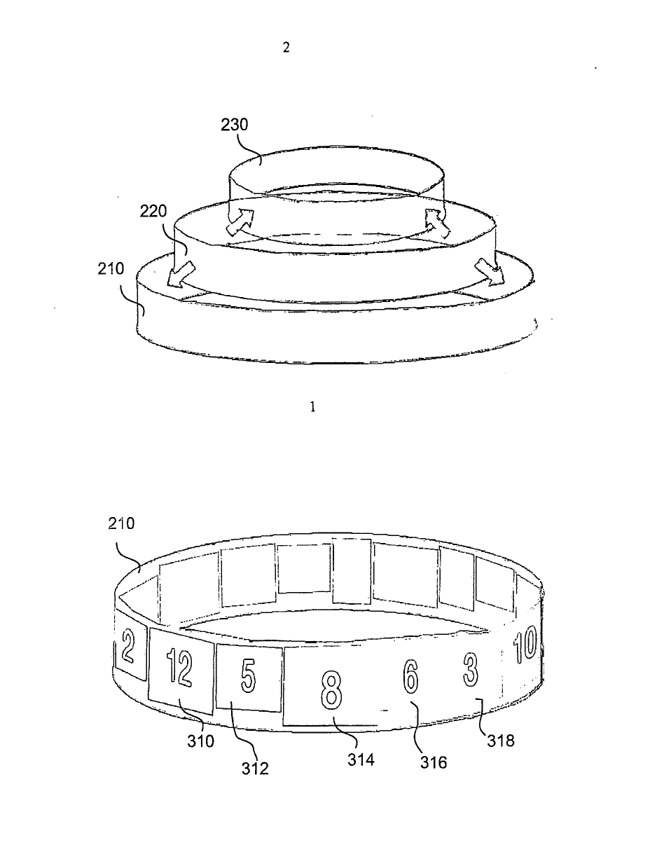

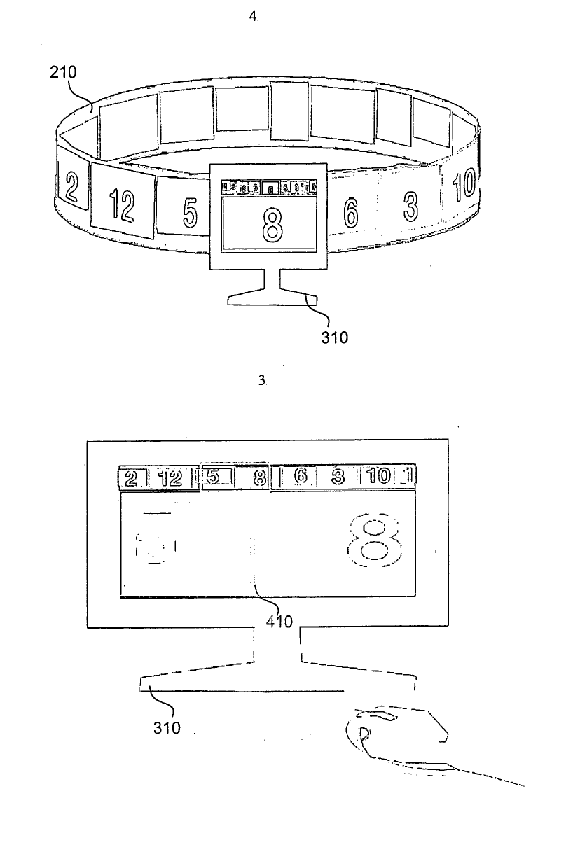

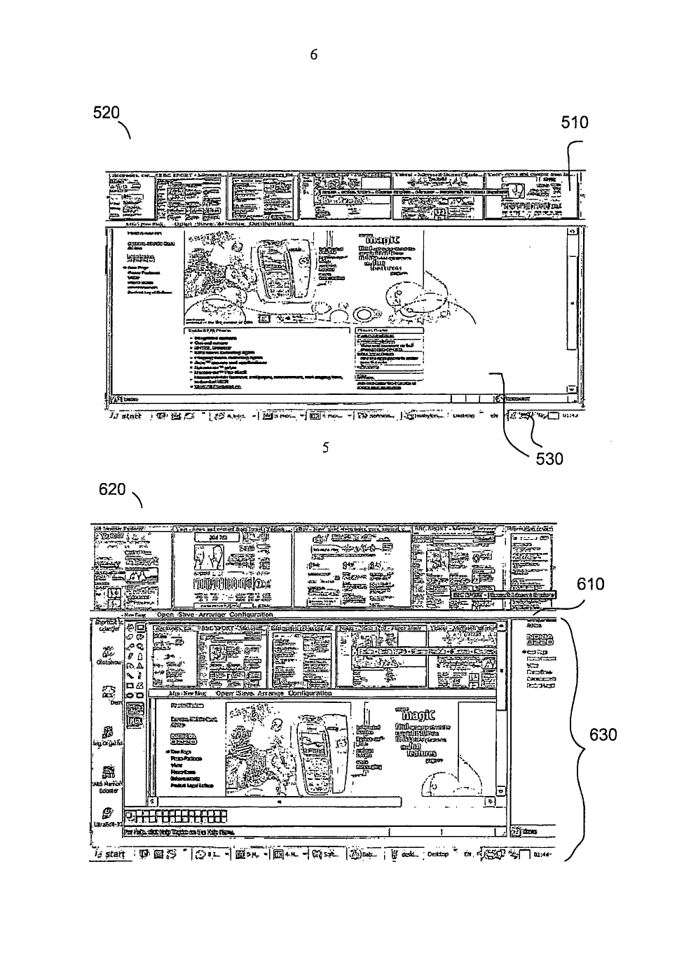

### MODES FOR CARRYING OUT THE INVENTION

Turning to FIG. 7, principal preferred embodiments of the instant invention relate to A Virtual Desktop—Meta-Organization & Control System, for use in a computer-processing environment having therein at least one processing unit with a respective operating-system, and the Virtual Desktop “software” system (120) comprises: A. In a real-time-accessible memory media, at least one dynamic substantially cyclic electronic-data structure (130); B. Associated with each said data structure, an ongoing algorithmic activity (140) that is respectively regularly (I.) Based on respective operating-system (100) data access, Transforming (142) each process, of a plurality of processes running in the environment or in a predetermined portion thereof, into an associated graphic representation, and (II.) Logically assigning (144) the representation to a location in the data structure; and C. Associated with each said data structure, a graphic user interface (150) facilitating (I.) On a display device (190), viewing (152) of the representations assigned to at least one of the data structures or to a portion thereof, and (II.) Organizing (154) of the at least one data structure.

There are two parts of the currently best enabled mode of this software that include somewhat tricky interface to the OS (element B.I above), both are required to allow the Mini-Map module (element C.I above) of the software display the miniature representation of an application window. The difficulty is present because (at most times) the applications windows on a common ring-oriented desktop are not directly displayed on the screen. While it is east and common practice to capture the graphic content of an on-screen window (and then a simple matter of shrinking it), there is no straightforward way to capture the graphic contents of an off-screen window. There are two versions of the problem, and accordingly two solutions:

Some applications make it easier to capture their graphic contents, such as for example the Microsoft Internet Explorer. The IE application is actually a wrapper for a IE browser “component”, with a standard interface. One of the methods of the interface is specifically designed to allow the capturing of the graphic contents of the browser. However, this interface is only useable within the same application, while we need to capture the content of different applications. To do this, we use a special injection technique (somewhat “hackish” technique, but well-documented) to insert an agent into the IE process. The agent is able to capture the graphic contents, and then to pass is through standard IPC (Inter-Process Communication) to the main application, which then shrinks it and displays it on the Mini-Map.

The problem is made more difficult with “dumb” applications that have no pre-designed interface such as the one present in IE. In that case, more sophisticate techniques must be put to use. Again, we inject an agent into the host application. However, this time we use the aforementioned “API hooking” trick in order to hook all the standard OS painting interfaces, and then we intervene in the middle and trick the application into drawing itself onto a memory “screen object” (while thinking it draws to the actual screen). The agent can then follow to send this memory screen object to the main application through standard IPC, as before.

The Core Technology Embodiment

The basic Loop (cyclic data structure) navigation can be done with the mouse, there are two default interfaces. These interfaces can be configured from the settings panel.

A. Scroll by relative mouse movement—Is activated by: Holding down the <CTRL>key+the right mouse button or by Holding middle mouse button; When moving the mouse left or right, the scroll speed is in direct proportion to the horizontal movement of the mouse.

B. Scrolling by mouse on screen edge—The view is scrolled by placing the mouse on the sides of the screen. The scroll speed is proportional to the vertical position of the mouse: Faster on the top, and slower on bottom.

C. Options menu—Activated from the Tray Icon by clicking the right mouse button on the predetermined “DeskLoops” icon in the right corner of the taskbar, or from the map. Double-clicking the “DeskLoops” icon activates the “Arrange” option, which spreads all the open windows on the Loop.

D. Navigation map—Appears when placing the mouse on the top of the screen, used for/to: View the entire Loop, or part of the Loop; Jumping to a window—by clicking it; Closing windows—by right mouse button; Setting window as sticky (always in view)—by right mouse button; and the map can be resized by dragging the lower edge of the map window.

The Core Technology Embodiment—Executable Code Structure

A list of the main modules in the software and their function:

1. UIManager (UI). This module is responsible for collecting all system-wide user input. It tells when the user presses or moves the mouse, if the map must be shown or hidden, if user-scrolling is initiated or terminated, etc.
2. MapManager (MAP). This module is responsible for the displaying the Mini-Map and processing user-input on the Mini-Map itself.
3. AnimatorManager (ANIM). This module is responsible for combining all possible scrolling and movement commands that occur in the system at different a synchronized times into one fluent and (30 ms) synchronized movement. It receives all movement commands from all other modules in the system, and “cuts” them into 30 ms pieces, which it feeds into the ScrollManager.
4. SystemHookManager (SYSHOOK). This module is responsible for communicating with OS through trapping OS events. It detects whenever a window is opened or closed, moved, resized, or is graphically updated. It also detects changes in focus, and receives graphics content from other windows. The SystemHookManager Module involves some of the more tricky technical aspects of the implementation:
   a. The trapping of events is done with System-wide hooks, which must be placed in a different DLL than the main executable. This method loads the DLL into the address space of every other process in the system, and so there is the problem of communicating information back to the main application process. It can be done using standard Inter-Process communication (Events, Shared memory, etc').
   b. The trapping of graphics contents of other applications is also somewhat technically complicated. Some applications support a COM interface to receive the graphics contents (like Internet Explorer), yet many do not. Capturing the contents of these applications can be done by hooking into the drawing functions of the operating system. On the Windows OS, this is performed by the tricky yet by now well-documented technique of API hooking.
5. ScrollManager (SCROLLER): The scroll engine that performs a single movement command. In order to make a single scroll movement faster, not the entire screen is updated, but rather only the relevant parts that are visible. This way the individual applications are not required to re-draw themselves. The algorithm (attached) to do this is based on identifying the z-ordering of every visible window, and determining which part of it is visible at any given time.
   The following events take place between 06:00:00.00 and 06:00:00.03 (and every 30 milliseconds henceforth):
1. The system loops over all “Input Modules” and receives commands for the next cycle.
2. PhysicalToLogical( ): Read physical location content of screen to logical representation.
3. System dispatches commands by the order of arrival. Main commands and respective actions taken are:
   1) “Rotate Loop” (UI): Sends a discrete movement command to AnimatorManager module
   2) “Show map” (UI): Send an activation command to MapManager module.
   3) “Hide Map” (UI): Send a deactivation command to MapManager module.
   4) “End User Movement” (UI): Activate AWPP
   5) “MoveToWindow” (MAP): Send an animation command to AnimatorManager that brings the desired window to center.
   6) “ReorderLoop” (MAP/SYSTRAY): Rearrange windows so that no overlapping occurs.
   7) “SaveLoop” (MAP/SYSTRAY): The system goes over all window applications on the virtualLoop and saves respective info to a file.
   8) “LoadLoop” (MAP/SYSTRAY): The system reads information from the specified file, Executes the applications and places them on the Loop according to the information in the save file.
   9) “New window Create” (SYSHOOK): Calculate where the new window will be opened, and send an appropriate animation command to AnimatorManager.
   10) “Close Window” (SYSHOOK): Send an animation command to AnimatorManager that “closes up” the vacant space.
   11) “Switch Window” (SYSHOOK): This command is received from the SystemHookManager module when it identifies an external (user or OS) operation that switched window focus, like pressing alt-tab or a respective OS call. The system sends a “MoveToWindow” command for the appropriate window.
   12) “Scroll Command” (ANIM): This command is processed by ScrollManager module, which performs the single accumulated scrolling required for every window apart (and/or for the entire Loop).
   13) LogicalToPhysical( ): Update physical display from the internal logical representation.

The Core Technology Embodiment—Executable Code Core Algorithm Group (ECCAG):

WindowList *RectAlgorithm(WindowList *source)
{

CArray<WindowObject *, WindowObject *> &list=source−>list;
CArray<WindowObject *, WindowObject *> ylist;
CArray<sortstruct, sortstruct &> XArray;
CArray<sortstract, sortstract &> XUniqueArray;
CArray<sortstruct, sortstruct &> YArray;
CArray<sortstruct, sortstruct &> YUniqueArray;
CArray<backstruct, backstruct &> ThresholdArray;
CArray<backstruct, backstruct &> ThresholdUniqueArray;
CArray<CArray<BOOL, BOOL>, CArray<BOOL, BOOL> &> XMap;
CArray<CArray<BOOL, BOOL>, CArray<BOOL, BOOL> &> YMap;
CArray<CArray<CRect, CRect &>, CArray<CRect, CRect &> &> XRealRect;
CArray<CRect, CRect &> RectArray;
CArray<HWND, HWND &> ZOrderArray;
WindowList *rc = new WindowList;;
int i,j,k,l;
// stage 2.
for(i=0;i<list.GetSize( );i++) {

sortstruct temp;
temp.hWnd=list[i]−>hWnd;
temp.x=list[i]−>ws.left;
XArray.Add(temp);
temp.x=list[i]−>ws.right;
XArray.Add(temp);

}
// Here we perform a bubble sort
for(i=0;i<XArray.GetSize( );i++) {

sortstruct temp;
for(j=0;j<XArray.GetSize( )−1,j++) {

if(XArray[j].x>Xarray[j+1].x) {

temp=Xarray[j+1];
XArray[j+1]=XArray( )[j];
XArray[j]=temp;

}

}

}

// Remove duplicate entries

// XArray ==> XUniqueArray
for(i=0;i<XArray.GetSize( );i++)

XUniqueArray.SetAtGrow(i,XArray[i]);

// Remove the duplicate entries from XUniqueArray.
for(i=1;i<XUniqueArray.GetSize( );) {

int a,b;
a=XUniqueArray[i].x;
b=XUniqueArray[i−1].x;
if(a==b)

XUniqueArray.RemoveAt(i);

else i++;

}

// Stage 4

XMap.SetSize(XUniqueArray.GetSize( ));
for(i=0;i<XMap.GetSize( );i++)

XMap[i].SetSize(list.GetSize( ));

// stage 6
// first column gets special treatment
for(i=0;i<list.GetSize( );i++)

XMap[0][i]=RelateXWindow(XUniqueArray[0].x,list[i]−>hWnd,XArray);

for(j=1;j<XMap.GetSize( );j++) {

for(i=0;i<list.GetSize( );i++) {

XMap[j][i]=RelateXWindow(XUniqueArray[j].x,list[i]−>hWnd,XArray);
XMap[j][i]=(Xmap[j−1][i] \hat{ }XMap[j][i]);

}

}

#ifdef WINTESTDEBUG

afxDump.SetDepth(1);
afxDump << “Dumping XMap:\n”;
XMap.Dump(afxDump);
afxDump << “\n”;
afxDump.Flush( );

#endif

// For every column do:
for(j=0;j<XUniqueArray.GetSize( )−1;j++) {

// Create ylist - the sublist of a column.
ylist.RemoveAll( );
YArray.RemoveAll( );
YUniqueArray.RemoveAll( );
for(i=0;i<list.GetSize( );i++) {

if(XMap[j][i]) ylist.Add(list[i]);

}
// stage 2 again - this time for y
for(i=0;i<ylist.GetSize( );i++) {

sortstruct temp;
temp.hWnd=ylist[i]−>hWnd;
temp.y=ylist[i]−>ws.top;
YArray.Add(temp);
temp.y=ylist[i]−>ws.bottom;
YArray.Add(temp);

}
// Here we perform a bubble sort

for(l=0;l<YArray.GetSize( );l++) {
sortstruct temp;
for(i=0;i<YArray.GetSize( )−1;i++) {

if(YArray[i].y>YArray[i+1].y) {

temp=YArray[i+1];
YArray[i+1]=YArray[i];
YArray[i]=temp;

}

}

}
// Remove duplicate entries
for(i=0;i<YArray.GetSize( );i++)

YUniqueArray.Add(YArray[i]);

for(i=1;i<YUniqueArray.GetSize( );) {

if(YUniqueArray[i].y==YUniqueArray[i−1].y)

YUniqueArray.RemoveAt(i);

else i++;

}
// Normal size plus one to hold the totals
YMap.SetSize(YUniqueArray.GetSize( ));
ZOrderArray.RemoveAll( );
for(i=0;i<YUniqueArray.GetSize( );i++) {

HWND tmphwnd=NULL;
ZOrderArray.Add(tmphwnd);

}
for(i=0;i<YMap.GetSize( );i++) {

YMap[i].SetSize(ylist.GetSize( ));

}
// ZOrderWindowList is sorted from high to low, left to right
for(i=0;i<ylist.GetSize( );i++) {

if(YMap[0][i]=RelateYWindow(YUniqueArray[0].y,ylist[i]−>hWnd,YArray))

{

// See if we have to replace something
if(ZOrderArray[0]==NULL)

ZOrderArray[0]=ylist[i]−>hWnd;

else {

if(ZOrderWindowList.IsLeftOf(ylist[i]−>hWnd,ZOrderArray[0]))

ZOrderArray[0]=ylist[i]−>hWnd;

}

}

}
for(k=1;k<YMap.GetSize( );k++) {

for(i=0;i<ylist.GetSize( );i++) {

YMap[k][i]=RelateYWindow(YUniqueArray[k].y,ylist[i]−>hWnd,YArray);

if(YMap[k][i]=(YMap[k−1][i] \hat{ }YMap[k][i])) {

if(ZOrderArray[k]=NULL)

ZOrderArray[k]=ylist[i]−>hWnd;

else {

if(ZOrderWindowList.IsLeftOf(ylist[i]−>hWnd,ZOrderArray[k]))

ZOrderArray[k]=ylist[i]−>hWnd;

}

}

}

}

// Stage 11 - calculate the list of rectangles

CRect newRect;
newRect.left=XUniqueArray[j].x;
newRect.right=XUniqueArray[j+1].x;
for(k=0;k<YUniqueArray.GetSize( )−1;k++) {

if(ZOrderArray[k]) {

WindowObject *wo=new WindowObject;
newRect.top=YUniqueArray[k].y;
newRect.bottom=YUniqueArray[k+1].y;
wo−>ws=newRect;
wo−>hWnd=ZOrderArray[k];
rc−>list.Add(wo);

}

}

}
return rc;

}

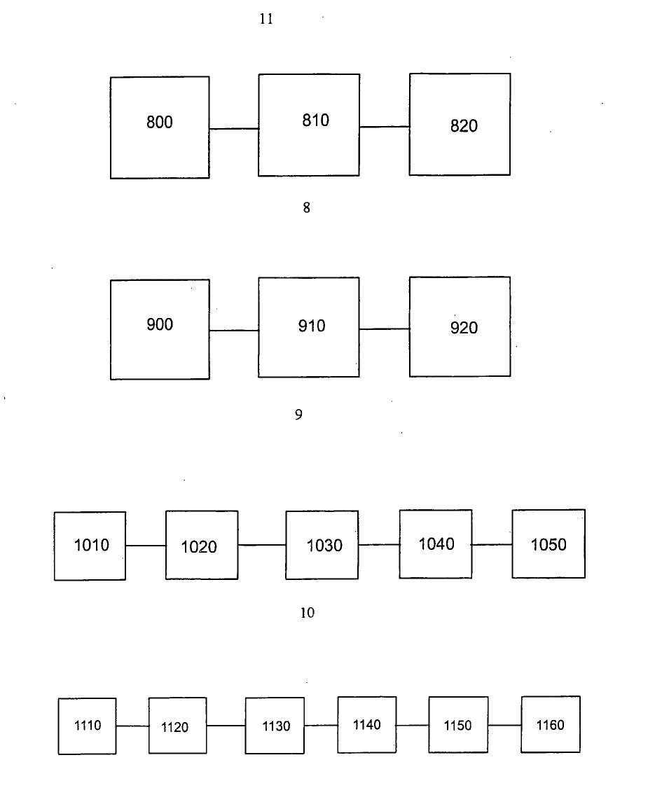

Thus, an embodiment of the instant invention Virtual Desktop—Meta-Organization & Control System (see FIG. 8) includes software for executing steps in a method for navigating between active applications in a computer system. This method comprising the steps of: On a user-screen, displaying (800) a substantially Loop shaped “virtual surface” having a plurality of areas each corresponding to a display-screen; Associating (810) a plurality of application window boundaries (processes running in the computer-processing environment of the user) with portions of the surface, whereby at least one pair of respective application window boundaries have at least one boundary associated with adjoined portion for the surface; and Navigating (820) from the respective application window by moving a pointing device across said at least one boundary.

Thus, another embodiment of the instant invention Virtual Desktop—Meta-Organization & Control System (see FIG. 9) includes software for executing steps in a method for navigating between active application in a computer system. This method comprising the steps of: providing (900) a substantially Loop shaped virtual surface, associating (910) windows with locations on the surface; and Navigating (920) between windows by moving across boundaries of the windows whereby a resultant window is the window that is associated with the location across the boundary on the surface.

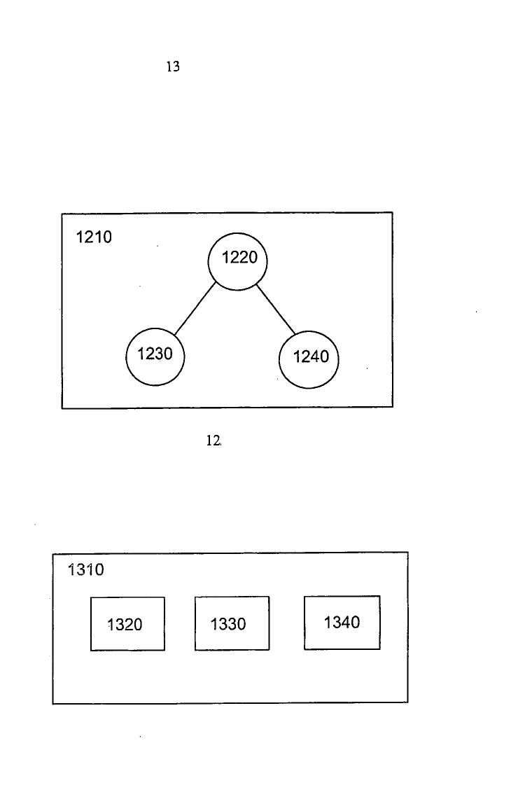

Furthermore, yet another embodiment of the instant invention Virtual Desktop—Meta-Organization & Control System (see FIG. 10) includes software for a virtual desktop. The virtual desktop comprising: a substantially Loop shaped virtual surface (1010) divided into portions corresponding to screens; application windows (1020) associated with portions of surface; a visible screen (1030) of the surface; application widows (1040) displayed in the visible screen; and User facility (1050) to rotate the surface—thereby exchanging visible screen portions therein.

Likewise, a further embodiment of the instant invention Virtual Desktop—Meta-Organization & Control System (see FIG. 11) includes software for executing steps in A method for providing a virtual desktop. This method including the steps of: Providing (1110) a virtual map surface, the map surface is a circular flat Loop; first Associating (1020) areas on virtual map surface with plurality of display areas, each one corresponding to physical display screen; second Associating (1130) application windows with at least one display area; Allowing (1140) navigation between display areas on surface to display associated applications on physical display screen; Adding (1150) areas to surface to accommodate application windows; and Arranging (1160) application windows continuously along surface screens without overlap.

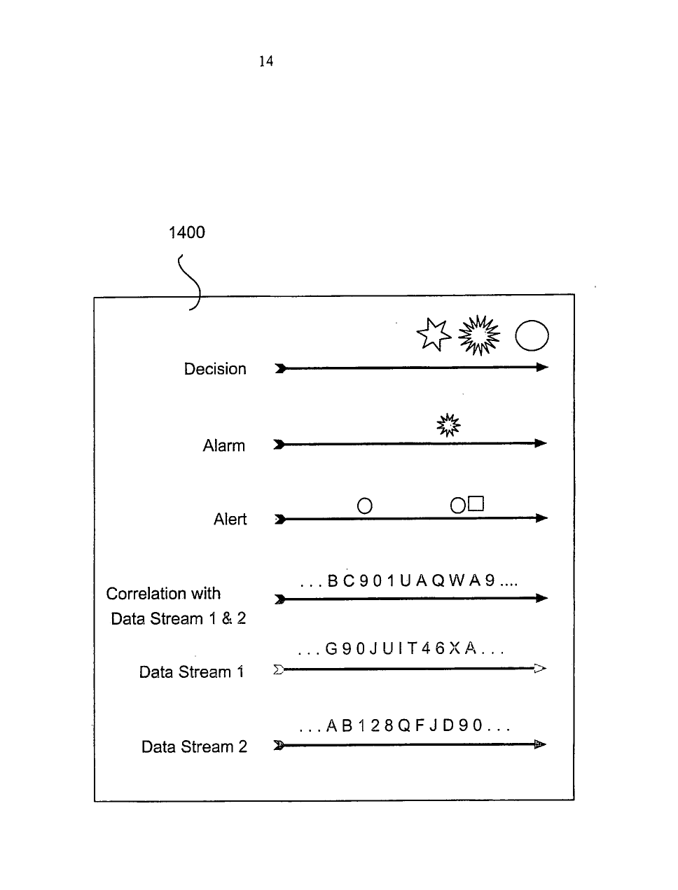

Turning to FIG. 12, in addition to all of the embodiments of the instant invention, as substantially described and illustrated herein, there is a parallel set of respective embodiments of the instant invention relating to An article of manufacture and/OR a computer program product including a computer usable medium (1210) having computer readable program code embodied therein for A Virtual Desktop—Meta-Organization & Control System, for use in a computer-processing environment having therein at least one processing unit with a respective operating-system, the computer readable program code in said article of manufacture including:

first computer readable program code (1220) for causing a computer to form and maintain at least one dynamic substantially cyclic electronic-data structure in a real-time-accessible memory media;

tied to the first computer readable software, second computer readable program code (1230) for causing the computer to Run an ongoing algorithmic activity (associated with each said data structure) that is respectively regularly (I) Based on respective operating-system data access, Transforming each process, of a plurality of processes running in the environment or in a predetermined portion thereof, into an associated graphic representation, and (II) Logically assigning the representation to a location in the data structure; and

tied to the first computer readable software, third computer readable program code (1240) for causing the computer to cause a graphic user interface (associated with each said data structure) to facilitate (I) On a display device, viewing of the representations assigned to at least one of the data structures or to a portion thereof, and (II) Organizing of the at least one data structure.

Likewise (tuning to FIG. 13), in addition to all of the embodiments of the instant invention, as substantially described and illustrated herein, there is a parallel set of respective embodiments of the instant invention relating to A program storage device (1310) readable by machine, tangibly embodying a program of instructions executable by the machine to perform method steps for A Virtual Desktop—Meta-Organization & Control System, for use in a computer-processing environment having therein at least one processing unit with a respective operating-system, said Virtual Desktop method steps including: (A) (1320) In a real-time-accessible memory media, forming and maintaining at least one dynamic substantially cyclic electronic-data structure; (B) (1330) Associated with each said data structure, Running an ongoing algorithmic activity that is respectively regularly (I) Based on respective operating-system data access, Transforming each process, of a plurality of processes running in the environment or in a predetermined portion thereof, into an associated graphic representation, and (II) Logically assigning the representation to a location in the data structure; and (C) (1340) Associated with each said data structure, a graphic user interface facilitating (I) On a display device, viewing of the representations assigned to at least one of the data structures or to a portion thereof, and (II) Organizing of the at least one data structure.

User's “Walk Through” of the Ordinary User Core Technology Embodiment

The ordinary user core technology embodiment of the instant invention Virtual Desktop—Meta-Organization & Control System is called “DeskLoops”—which is software that is composed of two main parts—a novel display manager, and a complementing “Mini-Map” desktop navigation tool. “DeskLoops” software provides a virtual desktop, which is intuitive and manageable. Essentially “DeskLoops” creates a new virtual concept “loop” (a substantially cyclic electronic-data structure and visualization thereof) while the application windows are placed one next to other in the visualization (instead of overlapping each other).

Basically, DeskLoops introduces a new “loop” concept of desktop meta-organization and (process) control. The core of this concept is to make managing the desktop intuitive and manageable by stretching (a visual transformation of processes that correspond to) items on the desktop along a virtual loop, thus allowing the user to smoothly and continuously rotate the desktop's loop visualization, and thereby achieving an effective desktop size as large as the user may wish to define.

The loop is “circular” (a dynamic substantially cyclic electronic-data structure); therefore, if the user scrolls to the right, the display will eventually return to its originally starting point. This way the user may never “get lost” in the loop environment.

When new window application is opened (e.g. Microsoft Explorer), it is integrated into the “loop” automatically or by double clicks on small icon placed on the task bar manager. The window can be integrated to the loop between the cute application's windows that the user sees on the screen, or to the “right end” of the loop. In the first case, the desktop will be stretch to the side and open “empty space” between the current application's windows displayed on the screen, a space where the new windows will be placed. The placement operation can be done with animation, or immediately. When a user closes an application, the loop will close up on the vacant space, maintaining uncluttered desktop.

The display manager is fully compatible with the operating system built-in methods for application manipulation.

Preferred Features

In order to provide efficiency and intuitive platform to the user, an Automatic Window Aligner feature is integrated into DeskLoops desktop platform. The Automatic Window Aligner is responsible to align the right or left side of the window to the side of the screen. This feature is very important, when the user open the applications' windows to full size display. In this case, the Automatic Window Aligner releases the user from scrolling the desktop to the exact position where right or left side of the window is aligned to the screen aide.

If the user wishes to move the position of a window, and then to place it into the “loop” again, it can be done very easily, by double clicking on an icon placed on the task bar manager.

When a user presses alt-tab or uses the task-bar to switch applications, then the loop will automatically rotate to bring the selected application into view. Furthermore, this platform enables the user to drag-and-drop (Microsoft Windows OS feature) between applications in a very easy manner. The user drags the object to the end of the screen until the destiny application is displayed, and simply drops the object in that application. ‘Sticky window’ feature enable the user to define an application window to retain its position on the screen, while the desktop is being scrolled. This feature can be used for applications such as a Music player; or any one that where the user wishes to have very quick access whiles keeping its window size relatively small.

DeskLoops software allows the user to save entire loop formations. The user may latter load an entire loop onto the desktop within a few seconds, thus creating pre-defined working environment.

Interface

The interface is simple and intuitive, based on the mouse, or any other pointing or scrolling device. As the user moves the mouse pointer to the right end of the display, the desktop automatically scrolls to the right, revealing the “hidden” part of the loop. The scrolling is continuous, and the speed of the scrolling may be controlled by the relative height of the mouse pointer on the display.

Another way of scrolling the desktop is by move the mouse to the direction, which the desktop should scroll to, while pressing on the mouse's middle button. For example: if the user presses the middle button and moves the mouse to the right, the desktop will scroll to the right. The speed of the scrolling of the desktop is dependent on the distance the mouse moved from the point when the user presses the middle button, and the current position of the mouse. As the distance gets bigger, the desktop will move faster.

The Mini-Map Navigation Tool

Additionally, DeskLoops includes a resizable Mini-Map display of the desktop. The Mini-Map is a miniature representation of the entire virtual desktop, and it is, in essence, an accurate and-complete scaled down version of the desktop. The user is able to see the contents of every single window or application, as they appear on the screen, in their scaled-down version. Changes to the desktop in a “hidden” part of the loop that is not currently displayed on screen are still reflected in the Mini-Map display. The user can change the number of application windows displayed at once on the Mini-Map by simply stretching the “bottom” of the Mini-Map up and down. When there are more application windows than can be displayed on the Mini-Map, the user can scroll the Mini-Map as well.

The Mini-Map may be used to easily navigate the loop—as a user clicks a window on the map, the loop will automatically rotate to the correct position in order to center that window on the display. In addition, the Mini-Map may be used to specifically manipulate any given window, application, or a defined group of windows on the desktop. The Mini-Map can be configured to auto-hide, and its display can be transparent.

Review Notes: Industrial Applicability of the Invention—Technical Issues: Embodied instantiations of the Virtual Desktop—Meta-Organization & Control System of the present invention are configurable with standard software functions—albeit complimented by well-publicized “hacker” techniques and tools.

Review Notes: Industrial Applicability of the Invention—Ergonomic Issues: Embodied instantiations of the Virtual Desktop—Meta-Organization & Control System of the present invention are intuitive—both from the vantage of their conceptual organization and from the vantage of ordinary interface interactions (keyboard commands, point and click actions, drag and drop actions, etc.).

Review Notes: Industrial Applicability of the Invention—Economic Issues: Embodied instantiations of the Virtual Desktop—Meta-Organization & Control System of the present invention are cost effective for ordinary and sophisticated users—unlike the resource heavy custom designed Virtual Desktop—Meta-Organization & Control Systems heretofore developed for activity coordinators (e.g. project management, air traffic control, C3, brokerage cash flow management for day trading groups, currency speculators, arbitrage speculators, etc.).

Features of Special Emphasis

“DeskLoops software allows the user to save entire loop formations. The user may latter load an entire loop onto the desktop within a few seconds, thus creating pre-defined working environment.” Even pre-define loops provide the ability to “snap shot” current states of working environment. The technology stretches the desktop along a virtual Loop, thus allowing the user to smoothly and continuously rotate the desktop, achieving an effective desktop size as large as the user may wish to define. (from the technology description doc). The user enjoys a very powerful desktop that reacts to the user need (of managing multiple windows, or just a few) automatically.

Regarding hand-eye coordination connection and navigate between plurality of applications, the Automatic Window Position Predictor (AWPP) feature of the system is designed to improve the user hand-to-eye coordination. The AWPP comes into action whenever the user initiates a Loop-movement. It computes the most likely ending-position of the current movement, and therefore is able to compensate for minor imprecision's of the user. For example, when the user moves the Loop towards a full-sized window and ends the movement while the aforementioned window is not aligned exactly to the borders of the display, the AWPP will presume that what the user actually wanted to achieve was to align the window with the display border, and so seamlessly correct the user input to achieve this end.

Display Features—Graphic User Interface “Special Emphasis” Program Functions

“Window Grouping”: This feature ascribes a window to a specific Loop position according to its content (and type of application). For example, one policy could be a group together all Word windows, so that whenever a new Word window is opened, it is positioned adjacent to the other open Word windows on the Loop.

“3D support”: Recently, 3D monitors had been introduced to the market. These monitors support a 3D illusion (similar to iMax cinemas). On such hardware, the system will facilitate a display of a larger part of the Loop, beyond the one screen-size that is possible on standard hardware. This will be accomplished by presenting a portion of the Loop that is adjacent to the foreground window in the 3D space of the display, so that the Loop will appear to be curved along the screen. The user will get the feeling that he is located at the center of the Loop.

“Sticky window” feature enables the user to define an application window to retain its position on the screen, while the desktop is being scrolled. This feature can be used for applications such as a Music player; or any application to which the user wishes to have very quick access whiles keeping its window size relatively small.

“Multiple monitors support”: The software supports a multiple-monitors display. The screen size will be computed as the total screen size of all monitors.

“Loop Compactification”: Normally, Web Pages are designed to be viewed by the user in “stand-alone” mode. That is, a single full-sized window. Therefore, many of them includes large margins that would otherwise be considered wasteful in a shared display environment. In a Loop-oriented display these margins are no longer necessary, and so, when enabled, this feature will automatically resize or otherwise alter Web Browsers to eliminate the wasteful margins, thus allowing the user to view more information in a compact and efficient way.

“Multiple Loop support”: The basic operation of the software is with one virtual Loop. In addition, the software supports the existence of multiple Loops simultaneously. The user may add, remove, name and configure the attributes of each Loop separately, and relocate windows from one Loop to another.

The software provides an interface that allows the user to quickly navigate between the Loops.

“Increased MAX window size”: In normal operation of the operating system, there is hardly any sense in allowing for windows larger than the size of the screen. However, the Loop-oriented display makes this option a viable one. The software therefore supports the existence of windows of a size larger than the screen. For example, Integrated Development Environments (such as Microsoft .NET IDE) could benefit from such an option.

NOTICE: In describing the present invention, explanations are presented in light of currently accepted Technological Theories (Software) or Mercantile Models (Management, Control, Organization, and the likes). Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

Numbers, alphabetic characters, and roman symbols are designated herein are for convenience of explanations only, and should by no means be regarded as imposing particular order on any method steps. Likewise, embodiments of the present invention are herein described with a certain degree of particularity. Specifically, the embodiments of the invention have been described with respect to specific examples including presently preferred modes of carrying out the invention, however those skilled in the art will appreciate that there are numerous variations and permutations of the above described systems and techniques that fall within the spirit and scope of the invention as set forth in the appended claims.

1. A Virtual Desktop for use in a computer-processing environment having at least one processing unit with a respective operating-system, and the Virtual Desktop comprises:
at least one dynamic substantially cyclic electronic-data structure;
associated with each said data structure, an ongoing algorithmic activity that is respectively regularly
transforming at least one process from a plurality of processes executing in the environment to an associated graphic representation;
logically assigning the representation to a location in the data structure; and
a graphic user interface facilitating displaying
on a display device, the representations assigned to at least a portion of the data structure, and
in response to data received from a user, modifying the assignment of representations to locations in the data structure.

2. A Virtual Desktop according to claim 1 wherein the at least one dynamic substantially cyclic electronic-data structure includes a reduced resolution meta-data-structure storing pointers to locations in the cyclic electronic-data structure.

3. A Virtual Desktop according to claim 1 wherein the ongoing algorithmic activity includes at least one program substantially as hereinbefore described and illustrated and selected from the list: UIManager (UI), MapManager (MAP), AnimatorManager (ANIM), SystemHookManager (SYSHOOK), ScrollManager (SCROLLER), Executable Code Core Algorithm Group (ECCAG).

4. A Virtual Desktop according to claim 1 wherein the graphic user interface includes at least one program function substantially as hereinbefore described and illustrated and selected from the list: Window Grouping, 3D support, Sticky window, Multiple monitors support, Loop Compactification, Multiple Loop support, Increased MAX window size.

5. A Virtual Desktop according to claim 1 wherein the associated graphic representation is selected from the group consisting of a high resolution snapshot of a GUI of the process, a low resolution snapshot of a GUI of the process, a symbolic graphic representation for the process, a high resolution data stream of a GUI of the process, a low resolution data stream of a GUI of the process, a symbolic graphic representation data stream for states of the process.

6. A Virtual Desktop according to claim 1 wherein the plurality of processes is selected from the group consisting of a
A. at least two programs selected from the group consisting of electronic mail, word processing, streaming media, net-radio, net-television, net-video, web browser, chat room, electronic messaging, graphic application package, PowerPoint, Architecture support program, interior design support program, CAD/CAM, accounting support program, spread-sheet program;
B. at least two programs selected from the group consisting of real time financial data stream presentation program, transaction events validation program, aggregate analysis of transaction events program, collective transaction management support program, financial analysis alert program, financial analysis alarm program, day-trader interaction program, brokerage management directive program;
C. at least two programs selected from the group consisting of project management program, supply chain program, scheduling program, accounting program, project coordination program, resource allocation program;
D. at least two programs selected from the group consisting of ECG monitor program, EEG monitor program, physiological monitor program, medical history report program, drug interaction program, medical expert system program, correlation of physiological monitors program, medical condition alerts program, medical condition alarm program, medical information system program;
E. at least two programs selected from the group consisting of genomic data base series display program, local search genomic fragment identification computation program, correlation to known organic compounds identification program, genomic computation strategy comparison program;
F. at least two programs selected from the group consisting of artistic composition arrangement protocol, orchestration program cinematography production management program, animation program audio special effects program, visual special effects program, multimedia performance event program, film editing program, audio editing program, audio mixing program, visual series mixing and sequencing program;
G. at least two programs selected from the group consisting of an interactive command-control facility program, an observation monitoring program, a passive viewing of status program, an alert activating program, an alarm activating program; and
H. a first program selected from any of the aforesaid groups, a second program selected from any of the aforesaid groups, and a third program interrelating data content from the first program with data content from the second program.

7. (canceled)

8. Virtual Desktop according to claim 1, further comprising storing said data structure in non-volatile memory and further comprising retrieving said data structure from said non-volatile memory and initiating said processes logically assigned to locations in the data structure by reference to the transformed graphical representation stored in said data structure.

9. A method of recalling an arrangement of program instances, comprising:
providing a user interface for adding at least one instance of a program to a data structure storing program instance indicators, each program including a graphical interface which is indicative of a state of said program instance, the data structure storing said instances has an ordered closed loop linked group;
associating each of said added instances with a graphical representation;
displaying a plurality of representations from the graphical representations associated with instances added to said data structure in a horizontal linked orientation whereby adjacent graphical representations share at least one image frame border;
providing an interface for a user to horizontally scroll said displayed representations to reveal additional representations associated with reciprocal representations by said closed loop linked group;
providing an interface for a user to recall an instance of a program corresponding to a displayed graphical representation by selecting said graphical representation from said display;
storing said data structure in non-volatile computer memory;
recalling said arrangement of program instances by retrieving said stored data structure for said non-volatile memory and displaying a plurality of the representations from graphical representations associated with instances stored in said data structure to allow the user to recall program instances.

10. The method of claim 9, further comprising providing a user interface for repositioning graphical representations within said horizontal display linked and updating data associated with at least one instant in said data structure in response to a user repositioning of a graphical representation associated with said instant.

11. The method of claim 9, further comprising periodically updating the program instance indicator for each instance in said data structure by reference to a current program instance state and updating said graphical representation for each said program instance.

12. The method of claim 9, further comprising in response to retrieving of said data structure initiating an instance of each program associated with an instance stored in said data structure, the initiating is of a state of the instance corresponding to the stored instance indicator in the data structure so as to have said instances available for providing to the user in response to user selection of graphical representations from said horizontal linked display.

13. A method for managing application instances on a computer system, comprising:
generating a bitmap representation for each of a plurality of application instances executing on a computer system;
associating the bitmap representations with relative positions by storing identifiers for each representation and corresponding application instance with a corresponding position in a data structure to provide an ordered bitmap set;
displaying at least one application instance as a first active application instance, said displaying is substantially over a lower portion of the computer display;
displaying the bitmap representation associated with the current active application instance and at least two other bitmap representations along substantially a top portion of said computer display, the bitmap representations arranged linearly, extending horizontally and arranged by reference to the relative positions stored in said data structure;
providing a user interface for requesting a horizontal displacement of said displayed bitmap representations;
displaying at least one additional bitmap representation along said top portion in response to a user request for horizontal displacement; and
modifying the displayed first active application instance in response to a user request for horizontal displacement, said second active application instances identified by reference to the relative positions of the first active application instance and the second active application instance.

14. A method for managing application instances on a computer system, comprising:
generating a bitmap representation for each of a plurality of application instances executing on a computer system;
associating the bitmap representations with relative positions by storing identifiers for each representation and corresponding application instance with a corresponding position in a data structure to provide an ordered bitmap set;
displaying at least one application instance as a first active application instance over a substantially lower portion of the computer display, the first active application instance associated with a first relative position;
displaying an adjacent application instance as the current active application instance, said adjacent application instance associated with a second relative position, in response to a user selection of a horizontal navigation control provided in said lower portion, said adjacent application instance identified by reference to said first relative position, said second relative position and the direction of horizontal navigation selected by said user; and
displaying the bitmap representation associated with the current active application instance and at least two other bitmap representations along a top portion of said computer display, the bitmap representations arranged linearly, extending horizontally and arranged by reference to the relative positions stored in said data structure.

15. The method of claim 14, further comprising modifying the relative position of said bitmap representations in said data structure by reference to user dragging of bitmap representations within said top portion display area.

16. A method for managing application on a computer system display, comprising:
generating a bitmap representation for each of a plurality of application instances executing on a computer system;
associating the bitmap representations with relative positions by storing identifiers for each representation and corresponding application instance with a corresponding position in a data structure to provide an ordered bitmap set;
associating each bitmap representation with a relative position by storing the identifiers in a second data structure;
recalling application instances associated with said first data structure in response to user selection of said first data structure;
recalling application instances associated with said second data structure in response to user selection of said second data structure;
displaying at least one application instance as a current active application instance, the current active application instance associated with a first relative position;
displaying the bitmap representation associated with the current active application instance and at least two other bitmap representations along a top portion of said computer display, the bitmap representations arranged linearly, extending horizontally and arranged by reference to the relative positions stored in said data structure.

17. The method of claim 16, further comprising viewing updated states of applications instances by displaying updated bitmap representations of the application instances while the active application instance is not included in the data structure of the strip.

18. The method of claim 16, further comprising facilitating drag and drop functions between the active application and the application instances associated with the bitmap representations by transferring dropped data to a corresponding application by reference to the data structure storing the applicable bitmap representation.

19. A method of recalling an arrangement of program instances, comprising:
providing a user interface for adding an instance of a program to a data structure storing program instance indicators, each program including a graphical interface which is indicative of a state of said program instance, the data structure storing said instances has an ordered closed loop linked group, the data structure further storing a location and size corresponding to each program instance;
storing said data structure in non-volatile computer memory;
recalling said arrangement of program instances by retrieving said stored data structure for said non-volatile memory and displaying a plurality of the representations from graphical representations associated with instances stored in said data structure by reference to said stored location and size for each program instance.

20. The method of claim 19, wherein said user interface comprises a user selection monitoring process that facilitates user selection of displayed data indicative of program instances and user direction of the selected data to the data structure so as to add the selected program instances to the data structure and further wherein said method automatically initiates the selected program instances in response to said user direction of the selected program instances to the data structure.

21. The method of claim 20, wherein said data structure further stored default data for program instance location and size which is referenced when automatically initiating program instances in response to said user direction.

22. The method of claim 20, wherein the user interface further includes an interface for specifying the position of the selected data within the data structure.
